(19) United States
(12) Patent Application Publication
(10) Pub. No.: US 2012/0211108 A1
(43) Pub. Date: Aug. 23, 2012

(54) FAUCET ASSEMBLY

(75) Inventor: Chia-Chang Yeh, Lukang Chen (TW)

(73) Assignee: ALEXANDER YEH INDUSTRY CO., LTD., Lukang Chen (TW)

(21) Appl. No.: 13/031,604

(22) Filed: Feb. 21, 2011

(51) Int. Cl. F16K 51/00

(52) U.S. Cl. 137/801

(57) ABSTRACT

A faucet assembly comprising an outlet portion, a switching valve, a locking pipe and a water inlet pipe assembly. The outlet portion is a tubular body having a water outlet end on a front end, a hole provided above the water outlet end, an inner periphery of the outlet portion provided with a switching port adjacent to the water outlet end, the outlet portion integrally formed with a connecting pipe at the switching port, the connecting pipe provided with a locking thread, a lower end of the connecting pipe provided with a locking hole, and a lower end of the water outlet portion is provided with a through-hole opposite to the locking hole. Since the outlet portion includes the connecting pipe, the locking pipe is disposed through the through-hole of the water outlet portion and locked with the locking hole, which provides for a more simple assembly and lower costs.

### BACKGROUND OF THE INVENTION

1. Field of the Invention

The present invention relates to a faucet assembly, and more particularly to a faucet assembly having an outlet portion with a connecting pipe; wherein a locking pipe is disposed through a through-hole of the water outlet portion and locked with the locking hole, which provides more simple assembly and lower cost.

2. Description of the Related Art

Currently, a prior art faucet assembly, as shown FIG. 8, comprises an outlet portion 50, a switching valve 60, a water inlet pipe assembly 70 and a connecting member 80. The outlet portion 50 has a water outlet end 51 and a through hole 52 at a bottom side of the outlet portion 50. The outlet portion 50 further has a switching port 53 adjacent to an inner periphery of the water outlet end 51, and the switching port 53 extends to form a connecting section 54. The outlet portion 50 further has a switching valve 60 disposed in the switching port 53, and the switching valve 60 includes a control rod 61 and a switching plate 62. The control rod 61 is disposed through the outlet portion 50, the switching plate 62 is attached at a lower section of the control rod 61, and the switching plate 62 has a sealing washer 61 adjacent to the switching port 53. The water inlet pipe assembly 70 comprises a coupling pipe 71, a connecting pipe 72 and a water-inlet pipe 73. The coupling pipe 71 is locked onto the connecting section 54 of the outlet portion 50, and the coupling pipe 71 further has a hole 712 such that the connecting member 80 is placed through the through hole 52 of the outlet portion 50 and an engaging slot 81 is engaged with the hole 712 of the coupling pipe 71. With the above-mentioned structure, when the control rod 61 of the switching valve 60 is pulled upwardly, the switch plate 62 seals the switching port 53, such that water can flow from the water inlet pipe assembly 70 to the connecting member 80. On the other hand, when the control rod 61 of the switching valve 60 is pressed downwardly, the switch plate 62 and the switching port 53 of the outlet portion 50 are separated, consequently, water can flow from the water inlet pipe assembly 70 to the water outlet end 51.

However, the prior art structure has the following drawbacks: since the coupling pipe 71 of the water inlet pipe assembly 70 is locked with the connecting section 54 of the outlet portion 50, it is difficult to align the hole 712 of the coupling pipe 71 with the through hole 52 of the outlet portion 50, which can lead to the engaging slot 81 of the connecting member 80 not being successfully engaged with the hole 712 and thus resulting in water leakage.

Therefore, it is desirable to provide a faucet assembly to mitigate and/or obviate the aforementioned problems.

### SUMMARY OF THE INVENTION

An objective of the present invention is to provide an improved faucet assembly.

In order to achieve the above-mentioned objectives, according to an embodiment of the present invention, a faucet assembly comprising an outlet portion, a switching valve, a locking pipe and a water inlet pipe assembly is disclosed wherein the outlet portion is a tubular body having a water outlet end on a front end, a hole provided above the water outlet end, an inner periphery of the outlet portion provided with a switching port adjacent to the water outlet end, the outlet portion integrally formed with a connecting pipe at the switching port, the connecting pipe provided with a locking thread, a lower end of the connecting pipe provided with a locking hole, and a lower end of the water outlet portion is provided with a through-hole opposite to the locking hole. The switching valve includes a control rod, a stopping piece and a sealing piece, the control rod being a stepped rod having a flange, the flange provided with a sealing ring, the control rod disposed through the hole of the water outlet portion, a bottom end of the control rod provided with a guiding cone, an annular insertion slot provided adjacent to the guiding cone, a side of the stopping piece formed with opposing engaging ribs, and the guiding cone is disposed through the engaging ribs with the engaging ribs being engaged in the insertion slot. When the stopping piece is disposed at the water outlet end, another side of the stopping piece is provided with an accommodating trough in which the sealing piece is received. An outer periphery of the locking pipe is provided with a locking thread, the locking pipe being disposed through the through-hole of the water outlet portion, the locking thread of the locking pipe engaged with the locking hole of the connecting pipe of the water outlet portion, and the water inlet pipe assembly is engaged with the locking thread of the connecting pipe of the water outlet portion.

According to the above-mentioned structure of the embodiment of the present invention, the following benefits can be obtained:

1. Since the outlet portion includes the connecting pipe, the locking pipe is disposed through the through-hole of the water outlet portion and locked with the locking hole, which provides for a more simple assembly and lower costs.

2. The upper locking thread of the locking pipe is coated with a waterproof glue to provide a sealing effect.

3. One side of the stopping piece is blocked by the stopping strips, such that the sealing piece of the stopping piece is disposed tightly adjacent to the switching port.

4. A border between the inner periphery of the water outlet portion and the connecting pipe is provided with a plurality of reinforcing ribs, which can improve the connection strength between the outlet portion and the connecting pipe.

5. The water inlet pipe assembly is gradually tapered, such that the water flow is smoother.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is another perspective view of an outlet portion of an embodiment of the present invention.

FIG. 4 is a cross-sectional view of an embodiment of the present invention.

FIG. 5 is a schematic drawing of an embodiment of the present invention.

FIG. 6 is a schematic drawing of a switching valve of a stopping piece and a switching port of an outlet portion being aligned according to an embodiment of the present invention.

FIG. 7 is a schematic drawing of the switching valve of the stopping piece and the switching port of the outlet portion being separated according to an embodiment of the present invention.

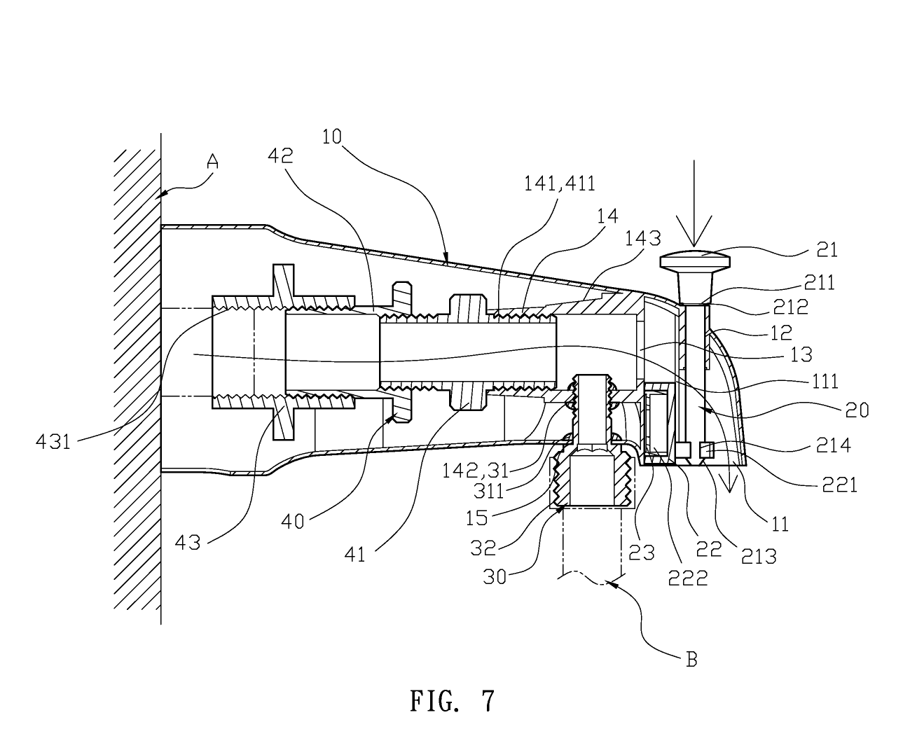

FIG. 8 is a cross-sectional view of a prior art.

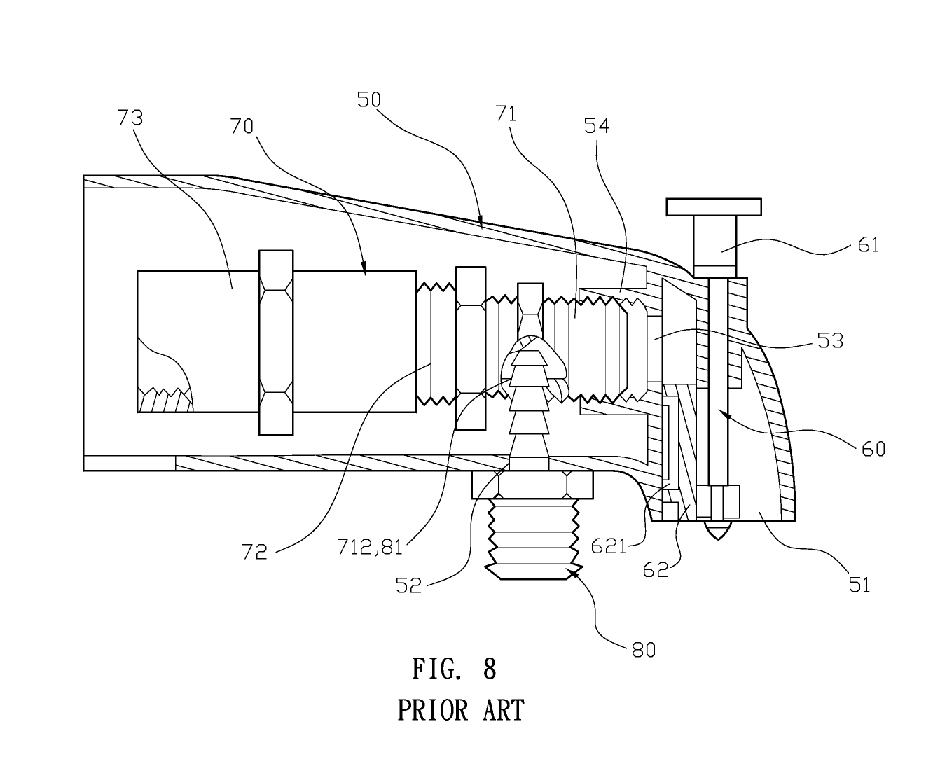

### DETAILED DESCRIPTION OF THE PREFERRED EMBODIMENT

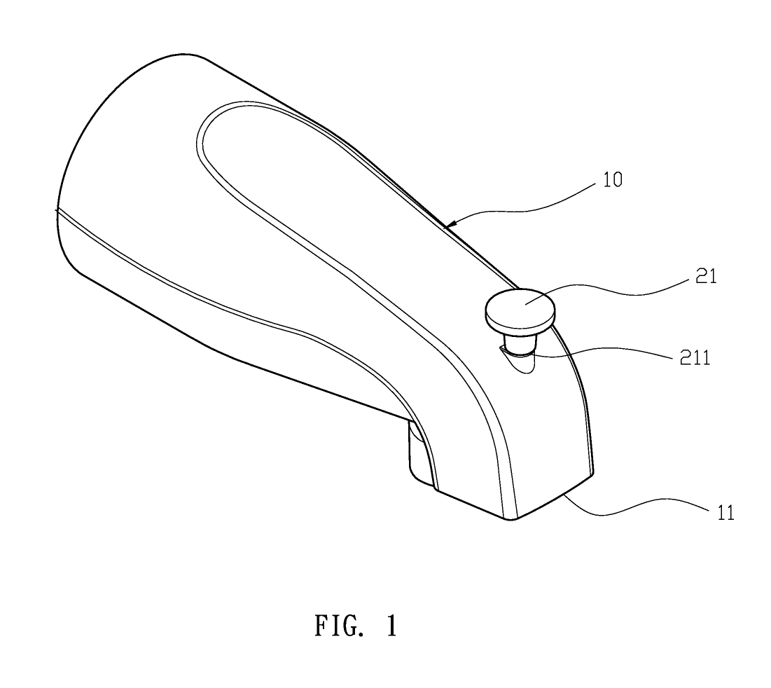

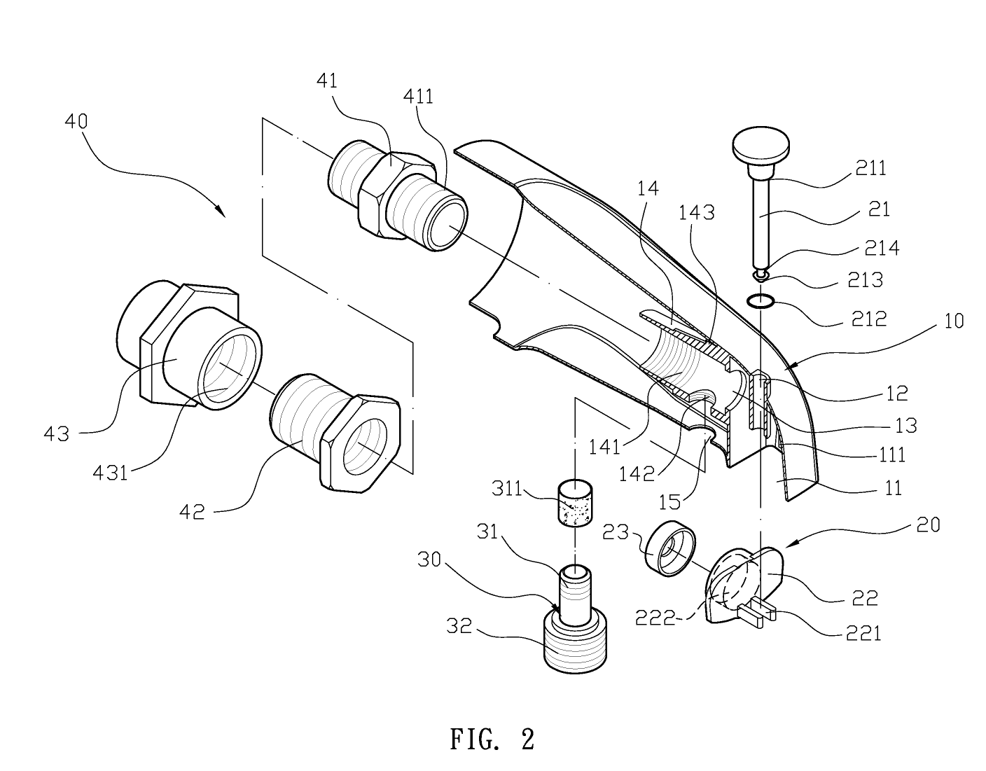

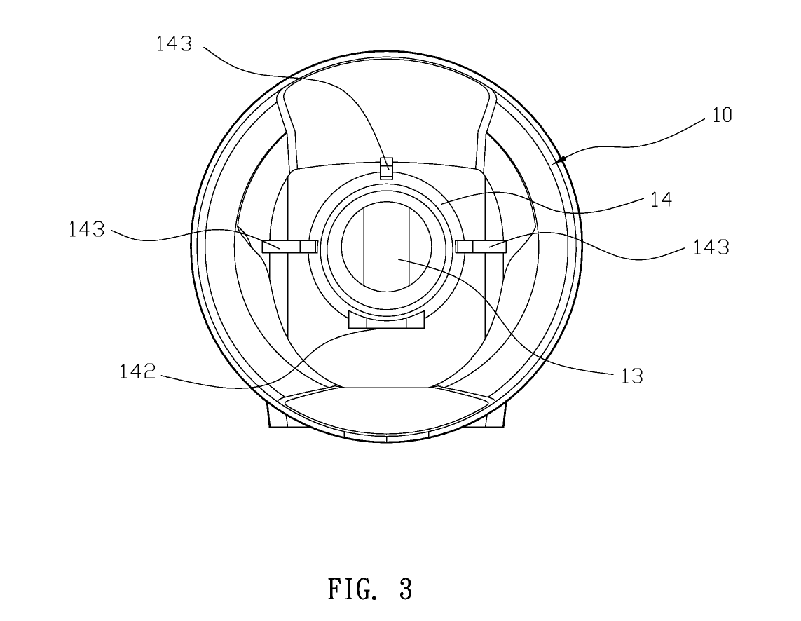

First, please refer to FIG. 1 and FIG. 2. A faucet assembly comprises an outlet portion 10, a switching valve 20, a locking pipe 30 and a water inlet pipe assembly 40. The outlet portion 10 is a tubular body having a water outlet end 11 on a front end, and both sides of an inner periphery of the water outlet end 11 are provided with opposing stopping strips 111. A hole 12 is provided above the water outlet end 11, and an inner periphery of the outlet portion 10 is provided with a switching port 13 adjacent to the water outlet end 11. The outlet portion 10 is integrally formed with a connecting pipe 14 at the switching port 13. The connecting pipe 14 is provided with a locking thread 141, and a lower end of the connecting pipe 14 is provided with a locking hole 142. A border between the inner periphery of the water outlet portion 10 and the connecting pipe 14 is provided with a plurality of reinforcing ribs 143, as shown in FIG. 3. A lower end of the water outlet portion 10 is provided with a through-hole 15 opposite the locking hole 142. The switching valve 20 includes a control rod 21, a stopping piece 22 and a sealing piece 23. The control rod 21 is a stepped rod having a flange 211, and the flange 211 is provided with a sealing ring 212. The control rod 21 is disposed through the hole 12 of the water outlet portion 10, and a bottom end of the control rod 21 is provided with a guiding cone 213. An annular insertion slot 214 is provided adjacent to the guiding cone 213. A side of the stopping piece 22 is formed with opposing engaging ribs 221, and another side of the stopping piece 22 is provided with an accommodating trough 222 in which the sealing piece 23 is received. The locking pipe 30 is a stepped pipe, and the outer periphery of the locking pipe 30 is provided with an upper locking thread 31 and a lower locking thread 32. The upper locking thread 31 is engaged with the locking hole 142 of the connecting pipe 14 of the water outlet portion 10, and the upper locking thread 31 is coated with waterproof glue 311 to provide a sealing effect between the upper locking thread 31 and the locking hole 142. The water inlet pipe assembly 40 includes a coupling pipe 41, an extending pipe 42 and a water-inlet pipe 43. One end of the coupling pipe 41 is provided with a connecting section 411, and the connecting section 411 is engaged with the locking thread 141 of the connecting pipe 14 of the water outlet portion 10. The extending pipe 42 is locked between the coupling pipe 41 and the water-inlet pipe 43. Furthermore, the extending pipe 42 is larger than the coupling pipe 41 in diameter, and the water-entering pipe 43 is larger than the extending pipe 42 in diameter. An inner periphery of the water-inlet pipe 43 is provided with a locking thread 431.

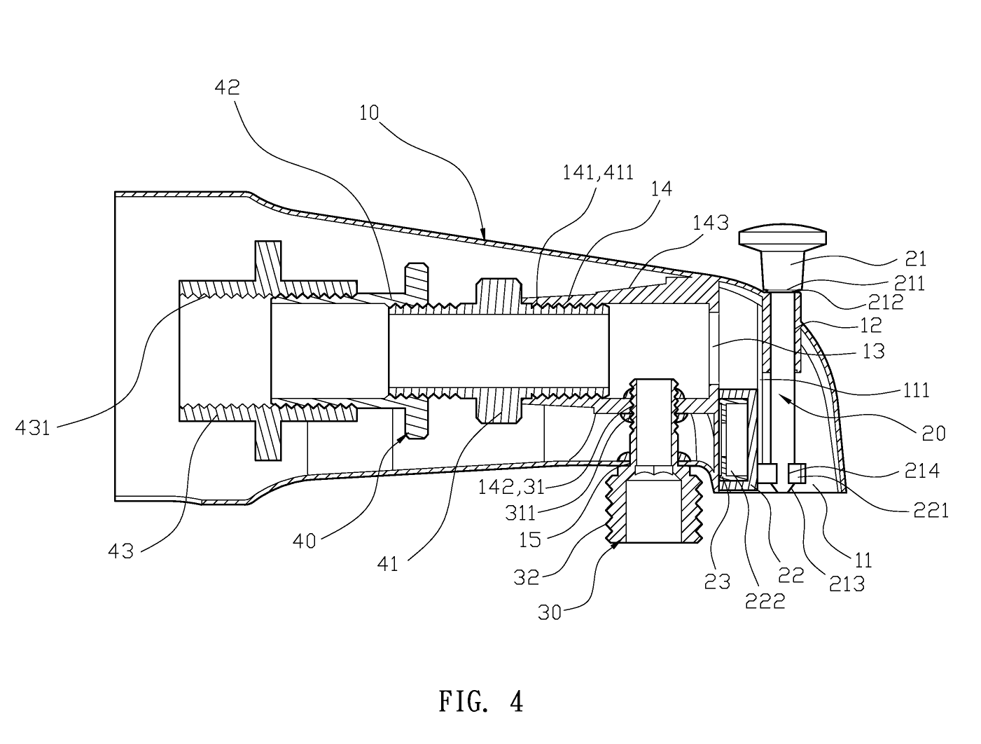

For actual assembly, please refer to FIG. 4 with FIG. 2. The control rod 21 of the switching valve 20 is placed through the hole 12 of the outlet portion 10, the stopping piece 22 is placed in the water outlet end 11 such that one side of the stopping piece 22 is blocked by the stopping strips 111, and the guiding cone 213 of the control rod 21 is disposed through the engaging ribs 221 of the stopping piece 22, such that the engaging ribs 221 are engaged in the insertion slot 214 and the upper locking thread 31 of the locking pipe 31 is engaged with the locking hole 142 of the connecting pipe 14 of the water outlet portion 10. Since the outlet portion 10 includes the connecting pipe 14, the locking pipe 30 is disposed through the through-hole 15 of the water outlet portion 10 and locked with the locking hole 142, and the connecting section 411 of the coupling pipe 41 of the water inlet pipe assembly 40 is engaged with the locking thread 141 of the connecting pipe 14 of the water outlet portion 10.

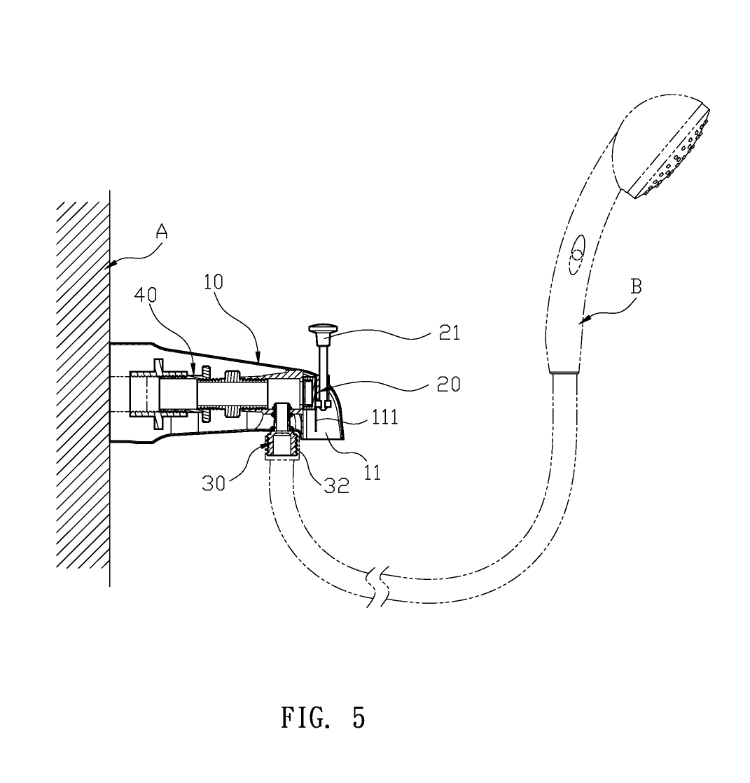

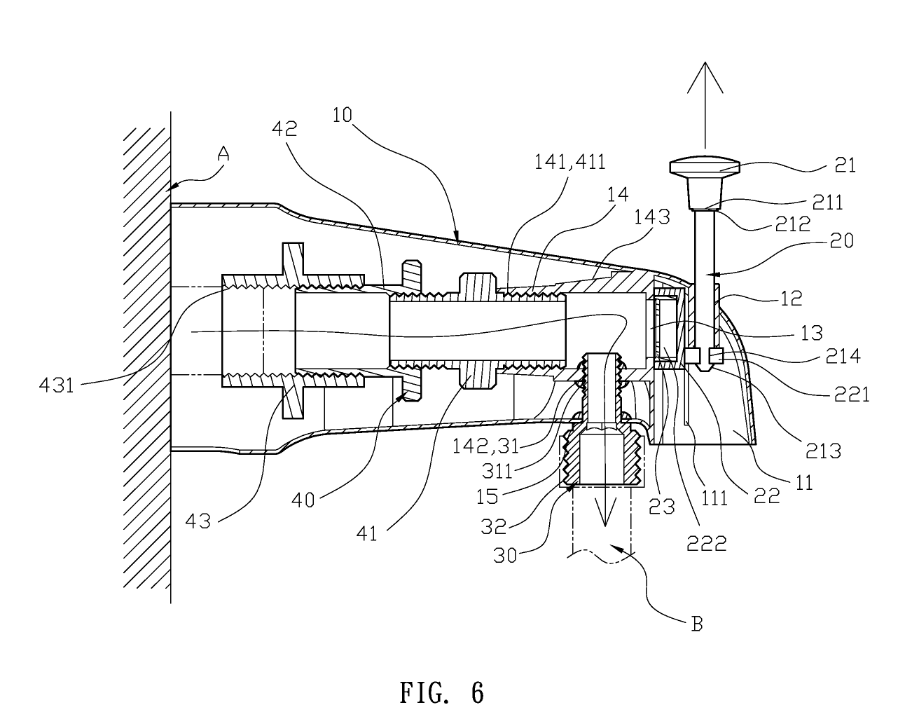

For actual use, please refer to FIG. 5 and FIG. 6. First, the water inlet pipe assembly 40 of the outlet portion 10 is attached onto a wall A, and the water inlet pipe assembly 40 is connected to an existing water source. The lower locking thread 32 of the locking pipe 30 is locked onto a water inlet end of a water spray device B. When the stopping piece 22 of the switching valve 20 is aligned with the switching port 13 of the outlet portion 10, water flows through the water-inlet pipe 43, the extending pipe 42 and the coupling pipe 41 of the water inlet pipe assembly 40, then the connecting pipe 14 of the outlet portion 10, the locking pipe 30 and the water inlet end of the water spray device B. When the control rod 21 of the switching valve 20 is pressed downwardly, the stopping piece 22 of the switching valve 20 and the switching port 13 of the outlet portion 10 are separated from each other; the water flows through the water-inlet pipe 43 the extending pipe 42 and the coupling pipe 41 of the water inlet pipe assembly 40, the connecting pipe 14 of the outlet portion 10, and then the switching port 13 into the water outlet end 11, as shown in FIG. 6.

According to the above-mentioned structure of the embodiment of the present invention, the following benefits can be obtained: 1. Since the outlet portion 10 includes the connecting pipe 14, the locking pipe 30 is disposed through the through-hole 15 of the water outlet portion 10 and locked with the locking hole 142, which provides for a more simple assembly and lower costs. 2. The upper locking thread 31 of the locking pipe 30 is coated with a waterproof glue 311 to provide a sealing effect. 3. One side of the stopping piece 22 is blocked by the stopping strips 111, such that the sealing piece 23 of the stopping piece 22 is disposed tightly adjacent to the switching port 13. 4. A border between the inner periphery of the water outlet portion 10 and the connecting pipe 14 is provided with a plurality of reinforcing ribs 143, which can improve the connection strength between the outlet portion 10 and the connecting pipe 14. 5. The water inlet pipe assembly 40 is gradually tapered, such that the water flow is smoother.

Although the present invention has been explained in relation to its preferred embodiment, it is to be understood that many other possible modifications and variations can be made without departing from the spirit and scope of the invention as hereinafter claimed.

What is claimed is:

1. A faucet assembly comprising an outlet portion, a switching valve, a locking pipe and a water inlet pipe assembly, wherein
the outlet portion is a tubular body having a water outlet end on a front end, a hole provided above the water outlet end, an inner periphery of the outlet portion provided with a switching port adjacent to the water outlet end, the outlet portion integrally formed with a connecting pipe at the switching port, the connecting pipe provided with a locking thread, a lower end of the connecting pipe provided with a locking hole, and a lower end of the water outlet portion is provided with a through-hole opposite to the locking hole;
the switching valve includes a control rod, a stopping piece and a sealing piece, the control rod being a stepped rod having a flange, the flange provided with a sealing ring, the control rod disposed through the hole of the water outlet portion, a bottom end of the control rod provided with a guiding cone, an annular insertion slot provided adjacent to the guiding cone, a side of the stopping piece formed with opposing engaging ribs, and the guiding cone is disposed through the engaging ribs with the engaging ribs being engaged in the insertion slot when the stopping piece is disposed at the water outlet end, another side of the stopping piece being provided with an accommodating trough in which the sealing piece is received; and
an outer periphery of the locking pipe is provided with a locking thread, the locking pipe being disposed through the through-hole of the water outlet portion, the locking thread of the locking pipe engaged with the locking hole of the connecting pipe of the water outlet portion, and the water inlet pipe assembly is engaged with the locking thread of the connecting pipe of the water outlet portion.

2. The recessed faucet structure according to claim 1, wherein both sides of an inner periphery of the water outlet end are provided with opposing stopping strips, and a side of the stopping piece is stopped by the stopping strips.

3. The recessed faucet structure according to claim 1, wherein a border between the inner periphery of the water outlet portion and the connecting pipe is provided with a plurality of reinforcing ribs.

4. The recessed faucet structure according to claim 1, wherein the locking pipe is a stepped pipe, the outer periphery of the locking pipe is provided with an upper locking thread and a lower locking thread, and the upper locking thread is engaged with the locking hole of the connecting pipe of the water outlet portion, the upper locking thread being coated with waterproof glue.

5. The recessed faucet structure according to claim 1, wherein the water inlet pipe assembly includes a coupling pipe, an extending pipe and a water-inlet pipe, one end of the coupling pipe provided with a connecting section, the connecting section engaged with the locking thread of the connecting pipe of the water outlet portion, the extending pipe locked between the coupling pipe and the water-inlet pipe, the extending pipe being larger than the coupling pipe in diameter, and the water-entering pipe is larger than the extending pipe in diameter, an inner periphery of the water-inlet pipe being provided with a locking thread.
